(19) United States
(12) Patent Application Publication
(10) Pub. No.: US 2005/0010769 A1
(43) Pub. Date: Jan. 13, 2005

(54) Domain authentication method for exchanging content between devices

(75) Inventors: Yong-Kuk You, Suwon-si (KR); Myung-Sun Kim, Euiwang-si (KR); Yang-Lim Choi, Sungnam-si (KR); Yong-Jin Jang, Gwacheon-si (KR); Su-Hyun Nam, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/779,881

(22) Filed: Feb. 18, 2004

(30) Foreign Application Priority Data
Jul. 11, 2003 (KR) 10-2003-0047430

(51) Int. Cl. G06K 9/00

(52) U.S. Cl. 713/168; 713/150; 725/25

(57) ABSTRACT

Disclosed is a domain authentication method for exchanging content between devices. The domain authentication method for exchanging content between devices according to the present invention includes a first step of setting domain identification information into a predetermined device connected on a wired/wireless network; a second step of generating a domain secret key using the set domain identification information and predetermined device identification information; a third step of generating a predetermined first code value and transmitting a first packet encrypted with the first code value using the domain secret key generated in the second step; a fourth step of receiving a second packet that is encrypted with the first code value and a second code value; and a fifth step of decrypting the second packet received in the fourth step.

### BACKGROUND OF THE INVENTION

This application claims the priority of Korean Patent Application No. 10-2003-0047430 filed on Jul. 11, 2003 in the Korean Intellectual Property Office, the disclosure of which is incorporated herein by reference.

1. Field of Invention

The present invention relates to a domain authentication method for exchanging content between devices.

2. Description of the Related Art

As a protocol for securely transmitting audio/video content (hereinafter, “AV content”) between two different devices, there are DTCP (Digital Transmission Content Protection) proposed by five companies including Hitachi, Ltd., Intel Corporation, Matsushita Electric Industrial Co., Ltd., Sony Corporation, and Toshiba Corporation and OCPS (Open Copy Protection System) proposed by Philips Electronics. These protocols are configured to exchange (140) contents between the two devices after two steps including a mutual authentication process (120) and a session key exchange process (130), as shown in FIG. 1. That is, each of the devices A 100 and B 110 confirms whether the other device is authentic through the mutual authentication process (120). If it is confirmed that both of the devices are authentic, the session key exchange process (130) of generating session keys to be used for encryption of the contents and exchanging them with each other is performed. Through the session key exchange process (130), the device A 100 and the device B 110 come to have the same session keys. After the session key exchange between the device A 100 and the device B 110 has been completed, the device intending to transmit the contents encrypts the contents, which are intended to be transmitted, using the already generated session keys, and then forwards the encrypted contents, while the device to receive the forwarded contents decrypts the received contents using the already generated session keys (140). The protocols for the protection of contents between devices confirm only whether the devices for transmitting and receiving the contents in the mutual authentication process (120) shown in FIG. 1 are manufactured through a regular process. Therefore, any users who purchased a device through a regular commercial route can receive contents from another device freely without limit. In such a case, however, the user who owns valuable contents such as AV contents has a difficulty in preventing any other users from receiving his/her contents despite an unwillingness to do so. Therefore, it is necessary for such a user to confirm whether the receiver has an authority to receive his contents.

### SUMMARY OF THE INVENTION

The present invention is contemplated for solving the aforementioned problems. An object of the present invention is to provide a method for performing a process of confirming a domain ID used for identifying a single local domain and allowing contents to be transmitted or received only between devices having the same domain IDs, thereby preventing devices of other users, which do not belong to the same domain, from performing unauthorized transmission and reception of data.

According to an aspect of the present invention for achieving the above object, there is provided a domain authentication method for exchanging contents between devices, comprising the steps of setting domain identification information into a predetermined device connected on a wired/wireless network, and generating a domain secret key using the set domain identification information or using the set domain identification information and predetermined device identification information.

According to another aspect of the present invention for achieving the object, there is also provided a domain authentication method for exchanging contents between devices, comprising a first step of setting domain identification information into a predetermined device connected on a wired/wireless network; a second step of generating a domain secret key using the set domain identification information and predetermined device identification information; a third step of generating a predetermined first code value and transmitting a first packet encrypted with the first code value using the domain secret key generated in the second step, as an example of determining whether the device owns the domain secret key; a fourth step of receiving a second packet that is encrypted with the first code value, which has been decrypted from the first encrypted packet using the domain secret key generated in the second step, and a second code value generated by the other device; and a fifth step of decrypting the second packet received in the fourth step by using the domain secret key generated in the second step and determining whether a specific bit frame of the decrypted second packet is equal to the predetermined first code value generated in the third step. Preferably, the domain secret key is set as a resultant value of a cryptographic one-way function or hash function whose input variables are the domain identification information and device identification information. More preferably, the first and second code values are predetermined bits of random numbers generated by the devices themselves, respectively.

Furthermore, the fifth step in the domain authentication method of the present invention may further comprise the step of generating a session key to be used for content encryption when the specific bit frame of the second decrypted packet is equal to the predetermined first code value generated in the third step, or terminating a domain authentication process when the specific bit frame is not equal to the first code value. In addition, the fifth step of the domain authentication method of the present invention may further comprise the step of transmitting another specific bit frame of the second decrypted packet when the specific bit frame of the decrypted packet is equal to the predetermined first code value generated in the third step.

According to yet another aspect of the present invention for achieving the object, there is provided a domain authentication method for exchanging contents between devices, comprising a first step of performing mutual authentication for the devices using device identification information; a second step of setting domain identification information into a predetermined device connected on a wired/wireless network; a third step of generating a domain secret key using the set domain identification information and predetermined device identification information; a fourth step of generating a predetermined first code value and transmitting a first packet encrypted with the first code value using the domain secret key generated in the third step; a fifth step of receiving a second packet that is encrypted with the first code value, which has been decrypted from the first encrypted packet using the domain secret key generated in the third step, and a second code value generated by the other device; and a sixth step of decrypting the second packet received in the fifth step by using the domain secret key generated in the third step and determining whether a specific bit frame of the decrypted second packet is equal to the predetermined first code value generated in the fourth step. Preferably, the domain secret key is set as a resultant value of a cryptographic one-way function or hash function whose input variables are the domain identification information and device identification information. More preferably, the first and second code values are predetermined bits of random numbers generated by the devices themselves, respectively.

Furthermore, the sixth step in the domain authentication method of the present invention may further comprise the step of generating a session key to be used for content encryption when the specific bit frame of the second decrypted packet is equal to the predetermined first code value generated in the third step, or terminating a domain authentication process when the specific bit frame is not equal to the first code value. In addition, the sixth step of the domain authentication method of the present invention may further comprise the step of transmitting another specific bit frame of the second decrypted packet when the specific bit frame of the decrypted packet is equal to the predetermined first code value generated in the fourth step.

### BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates a process of exchanging content between devices according to the prior art;

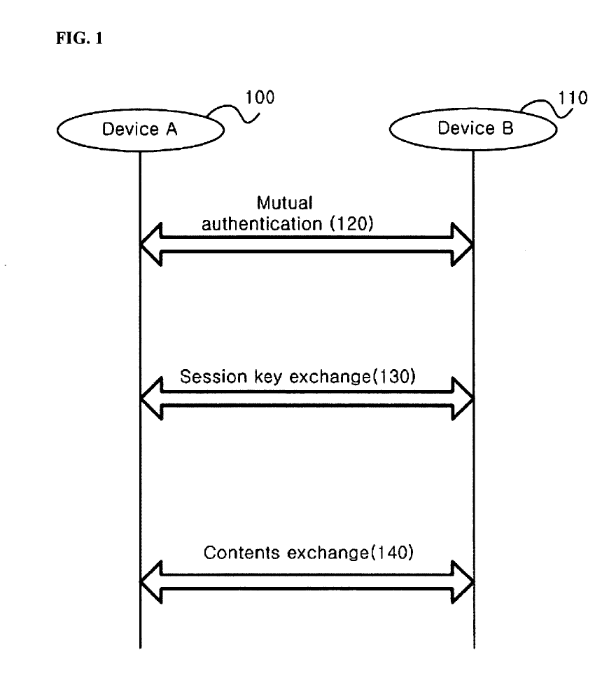

FIG. 2 illustrates a process of exchanging content between devices including a domain authentication process according to the present invention;

FIG. 3 illustrates the domain authentication process between devices according to the present invention;

FIG. 4 is a flowchart illustrating an exemplary embodiment of the process of exchanging content, including the domain authentication process according to the present invention; and

FIG. 5 is a flowchart of illustrating an exemplary embodiment of the domain authentication process between devices according to the present invention.

### DETAILED DESCRIPTION OF THE INVENTION

Hereinafter, a domain authentication method for exchanging content between devices according to an exemplary embodiment of the present invention will be described with reference to the accompanying drawings.

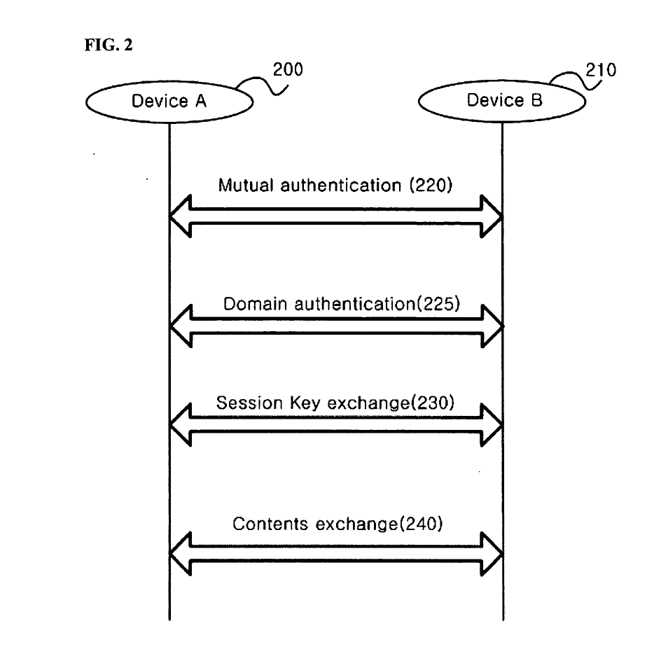

FIG. 2 illustrates a process of exchanging content between devices including a domain authentication process according to the present invention. Referring to FIG. 2, device A 200 and device B 210 confirm whether the other is an authentic device through a mutual authentication process (220). If it is confirmed that both devices are authentic, a process of confirming whether both have the same domain IDs is performed (225). If it is confirmed that the device A 200 and the device B 210 have the same domain IDs, a session key exchange process of generating session keys used for encrypting the contents and exchanging them with each other is performed (230). Through the session key exchange process (230), the device A 200 and the device B 210 come to have the same session keys. After the session key exchange between the device A 200 and the device B 210 has been performed, the device intending to transmit the contents encrypts the contents, which are intended to be transmitted, using the already generated session keys and then forwards the encrypted contents, while the device to receive the forwarded contents decrypts the received contents using the already generated session keys (240).

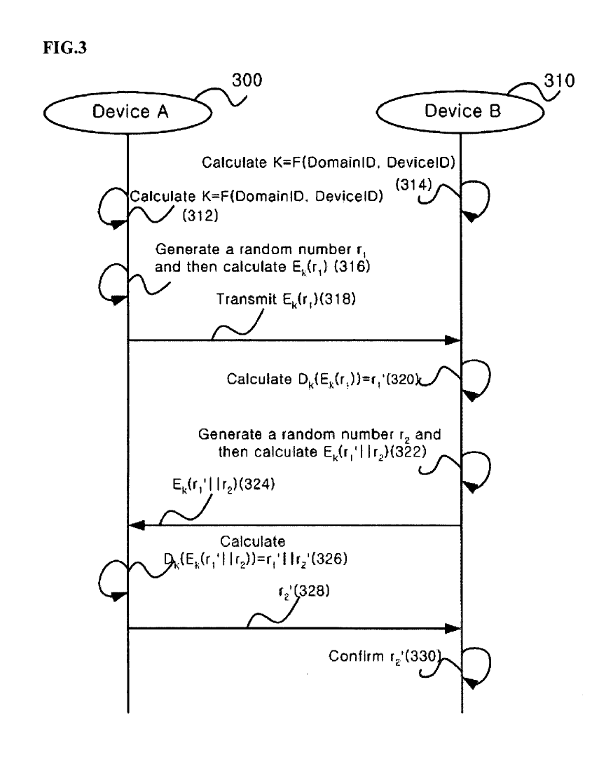

FIG. 3 shows the domain authentication process between the devices according to the present invention, and more specifically illustrates the domain authentication process (225) shown in FIG. 2. First, information on a domain identifier (hereinafter, referred to as “DomainID”) and respective device identifiers (hereinafter, referred to as “DeviceID”) for n devices belonging to a specific domain classified by the DomainID, needs to be set to respective devices belonging to a single local domain. Here, to manage the DomainID, a manager for managing a specific network can manually input the DomainID into a relevant device, or a server for managing the network can automatically generate the DomainID. Further, a MAC address can be generally used as the DeviceID. Device A 300 and device B 310 that intend to perform data transmission and reception generate the DeviceID by using DeviceID_1, DeviceID_2, . . . , DeviceID_n, which represent n device identifiers for configuring a specific domain, as input variables, and then, a secret value is generated by using the generated DeviceID or the already stored DomainID as an input variable (312, 314). That is, assuming that the secret key is K and a cryptographic one-way function is F, the secret key K can be expressed as the following equations (1) to (4). Here, a function H means a Hash function powerful in protecting contents.
K=F(DomainID, DeviceID) (1)
K=H(DomainID⊕H(DeviceID_1∥ . . . ∥DeviceID_n)) (2)
K=H(DomainID∥DeviceID_1∥ . . . ∥DeviceID_n)
K=H(DomainID∥H(DeviceID_1∥ . . . ∥DeviceID_n)) (3)
K=DomainID (4)

Here, for predetermined values A and B, “A∥B” means enumeration of the values A and B. If the device A 300 intends to receive predetermined contents from the device B 310 after the device A 300 and the device B 310 have generated the same secret key K, the device A 300 can confirm whether the device B 310 has the same secret key B as the device A 300 in various ways. One exemplary illustration may be as follows. The device A 300 generates a random number r1, which in turn is encrypted using the secret key K through a symmetric encryption function E (316). Here, assuming that the encrypted value is Eₖ(r₁), the device A 300 transmits the value of Eₖ(r₁) to the device B 310 (318). Meanwhile, the device B 310 decrypts the value of Eₖ(r₁) received from the device A 300 by using the already generated secret key K, so that a value of r₁′ can be obtained (320). Then, the device B 310 generates a random number r₂, and the values of r₂ and r₁′ are encrypted using the secret key K through the symmetric encryption function E (322). Here, assuming that the encrypted value is Eₖ(r₁′∥r₂), the device B 310 transmits the value of Eₖ(r₁′∥r₂) to the device A 300 (324). The device A 300 calculates and obtains a value of r₁′∥r₂′ by decrypting the value of Eₖ(r₁′∥r₂) received from the device B 310 using the secret key K and confirms whether the value of r₁′ is equal to the random number r₁ previously generated by itself (326). If they are equal to each other, the device A 300 transmits a value of r₂′ to the device B 310 (328), and then, the device B 310 confirms whether the received value of r₂′ is equal to the random number r₂ previously generated by itself (330). In such a manner, it can be confirmed that the device A 300 and the device B 310 belong to the same domain. Further, if they belong to the same domain, the session key exchange process (230) shown in FIG. 2 will be performed. On the other hand, if it is confirmed in steps (326) and (330) that the values of r₁′ and r₂′ are not equal to the random numbers previously generated by themselves, respectively, the domain authentication process is terminated, and then, a domain authentication failure message is generated and provided to the users of the respective devices.

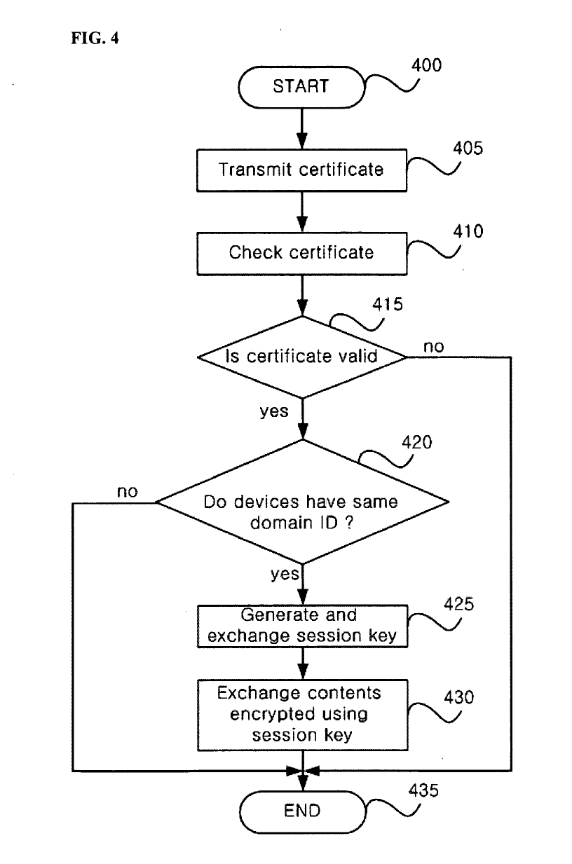

FIG. 4 is a flowchart illustrating the process of exchanging the contents between devices, including the domain authentication process according to a preferred embodiment of the present invention. Referring to FIG. 4, each of the devices that intend to transmit and receive content transmits its own certificate to the other device (S405), checks the received certificate of the other device (S410), and determines whether the received certificate is valid (S415). If it is determined that the certificate is not valid, the authentication process is terminated (S435). If it is determined the certificate is valid, it is checked whether the devices have the same domain IDs (S420). If it is checked that the devices do not have the same IDs, the authentication process is terminated (S435). If it is checked that the devices have the same domain IDs, they generate their own session keys and exchange the generated session keys with each other (S425) and finally exchange the encrypted content with each other using the session keys (S430).

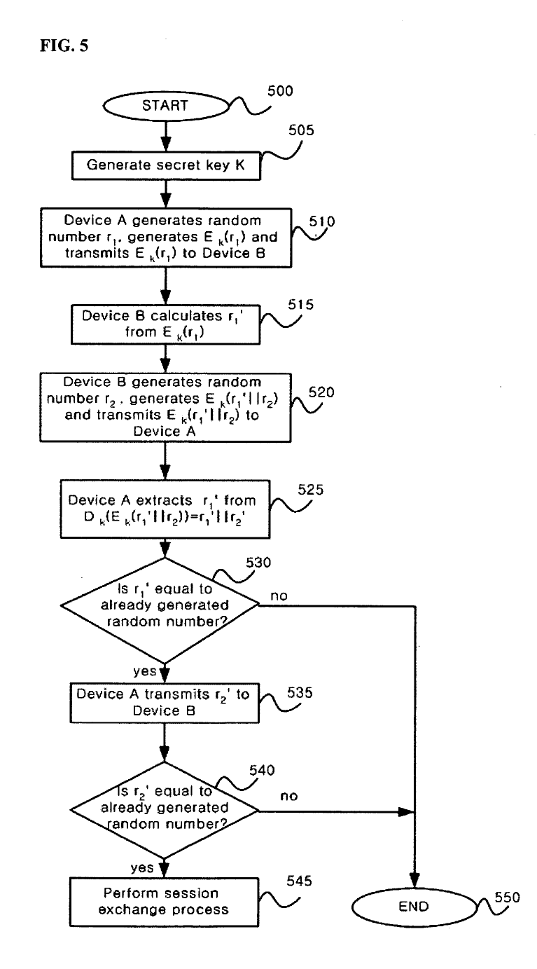

FIG. 5 is a flowchart illustrating the domain authentication process between devices according to an exemplary embodiment of the present invention. Referring to FIG. 5, if the device A and the device B that intend to transmit and receive content exist and the device A intends to receive predetermined content from the device B, a device authentication process for each device is first performed and the domain authentication process shown in FIG. 5 is then performed. After the device A and the device B generate their own secret keys K (S505), the device A generates a random number r₁, encrypts r₁ by using the secret key K, and forwards the encrypted value of r₁, i.e. a value of Eₖ(r₁), to the device B (S510). The device B calculates r₁′ with the received value of Eₖ(r₁) (S515). Then, the device B also generates a random number r₂, encrypts r₁′ and r₂ together using the secret key and forwards the encrypted value, i.e. a value of Eₖ(r₁′∥r₂), to the device A (S520). The device A decrypts the received value of Eₖ(r₁′∥r₂) and extracts the random number r₁′ (S525), and then checks whether the extracted random number r₁′ is equal to the random number r₁ previously generated by itself (S530). If it is checked that r₁′ is not equal to r₁, the domain authentication process is terminated (S550). If it is checked that r₁′ is equal to r₁, the device A forwards r₂′, which is extracted by decrypting the value of Eₖ(r₁′∥r₂), to the device B (S535). Then, the device B checks whether the received r₂′ is equal to the random number r₂ previously generated by itself (S540). If it is checked that r₂′ is not equal to r₂, the domain authentication process is terminated (S550). Otherwise, the session key exchange process is performed (S545).

According to the present invention so constructed, since a domain ID authentication process is added to the related art protocol for the protection of devices or contents, users belonging to different domains cannot transmit and receive content between each other without permission, and thus, the secure exchange of content can be performed.

Although the present invention has been described in connection with the embodiments illustrated in the drawings, it will be apparent to those skilled in the art that various substitutions, modifications and changes may be made thereto without departing from the technical spirit and scope of the invention. Thus, the present invention is not limited to the embodiments and the accompanying drawings.

1. A domain authentication method for exchanging content between devices, comprising the steps of:
setting domain identification information into a predetermined device connected on one of a wired network and a wireless network, and
generating a domain secret key using the set domain identification information.

2. A domain authentication method for exchanging content between devices, comprising the steps of:
setting domain identification information into a predetermined device connected on one of a wired network and a wireless network, and
generating a domain secret key using the set domain identification information and predetermined device identification information.

3. A domain authentication method for exchanging content between devices, comprising:
a first step of setting domain identification information into a predetermined device connected on one of a wired network and a wireless network;
a second step of generating a domain secret key using the set domain identification information and predetermined device identification information;
a third step of generating a predetermined first code value and transmitting a first packet encrypted with the first code value using the domain secret key generated in the second step;
a fourth step of receiving a second packet that is encrypted with the first code value, which has been decrypted from the first encrypted packet using the domain secret key generated in the second step, and a second code value generated by another device; and
a fifth step of decrypting the second packet received in the fourth step by using the domain secret key generated in the second step and determining whether a specific bit frame of the decrypted second packet is equal to the predetermined first code value generated in the third step.

4. The method as claimed in claim 3, wherein the domain secret key is set as a resultant value of a cryptographic one-way function whose input variables are the domain identification information and the device identification information.

5. The method as claimed in claim 3, wherein the domain secret key is set as a resultant value of a hash function whose input variables are the domain identification information and the device identification information.

6. The method as claimed in claim 3, wherein the first and second code values are predetermined bits of random numbers generated by the devices themselves, respectively.

7. The method as claimed in claim 3, wherein the fifth step further comprises the step of generating a session key to be used for content encryption when the specific bit frame of the second decrypted packet is equal to the predetermined first code value generated in the third step, or terminating a domain authentication process when the specific bit frame is not equal to the first code value.

8. The method as claimed in claim 3, wherein the fifth step further comprises the step of transmitting another specific bit frame, which is based on the second decrypted packet, when the specific bit frame of the decrypted packet is equal to the predetermined first code value generated in the third step.

9. A domain authentication method for exchanging content between devices, comprising;
a first step of performing mutual authentication for the devices using device identification information;
a second step of setting domain identification information into a predetermined device connected on one of a wired network and a wireless network;
a third step of generating a domain secret key using the set domain identification information and the predetermined device identification information;
a fourth step of generating a predetermined first code value and transmitting a first packet encrypted with the first code value using the domain secret key generated in the third step;
a fifth step of receiving a second packet that is encrypted with the first code value, which has been decrypted from the first encrypted packet using the domain secret key generated in the third step, and a second code value generated by another device; and
a sixth step of decrypting the second packet received in the fifth step by using the domain secret key generated in the third step and determining whether a specific bit frame of the decrypted second packet is equal to the predetermined first code value generated in the fourth step.

10. The method as claimed in claim 9, wherein the domain secret key is set as a resultant value of a cryptographic one-way function whose input variables are the domain identification information and the device identification information.

11. The method as claimed in claim 9, wherein the domain secret key is set as a resultant value of a hash function whose input variables are the domain identification information and the device identification information.

12. The method as claimed in claim 9, wherein the first and second code values are predetermined bits of random numbers generated by the devices themselves, respectively.

13. The method as claimed in claim 9, wherein the sixth step further comprises the step of generating a session key to be used for content encryption when the specific bit frame of the second decrypted packet is equal to the predetermined first code value generated in the fourth step, or terminating a domain authentication process when the specific bit frame is not equal to the first code value.

14. The method as claimed in claim 9, wherein the sixth step further comprises the step of transmitting another specific bit frame, which is based on the second decrypted packet, when the specific bit frame of the decrypted packet is equal to the predetermined first code value generated in the fourth step.
